(19) United States
(12) Patent Application Publication
(10) Pub. No.: US 2021/0340294 A1
(43) Pub. Date: Nov. 4, 2021

(54) SPRAYABLE POWER OF FLUOROPOLYER PARTICLES

(71) Applicant: 3M INNOVATIVE PROPERTIES COMPANY, St. Paul, MN (US)

(72) Inventors: Andreas M. Gledmacher, Dormagen (DE); Fee Zentis, Waging am See (DE); Michael Maerz, Neuss (DE); Klaus Hintzer, Kastl (DE); Harald Kaspar, Burgkirchen (DE); Jens Eichler, Kaarst (DE); Gabriele H. Gottschalk-Gaudig, Mehring (DE)

(21) Appl. No.: 17/286,536

(22) PCT Filed: Oct. 16, 2019
(86) PCT No.: PCT/IB2019/058833

§ 371 Date: Apr. 19, 2021

(30) Foreign Application Priority Data
Oct. 19, 2018 (EP) 18201540.4

(51) Int. Cl. C08F 214/26; C08J 3/12; B33Y 70/00

(52) U.S. Cl. CPC C08F 214/26; C08J 3/122; C08J 3/124; B29C 64/153; C08J 2323/28; C08J 2327/18; B33Y 70/00

(57) ABSTRACT

The present disclosure relates to a fluoropolymer powder for additive manufacturing of fluoropolymers having an average particle size (d₅₀) in a range from 20 to 100 micrometers, preferably 30 to 70 micrometers, more preferably from 30 to 65 micrometers, most preferably from 30 to 60 micrometers and an average particle size (d₉₀) in a range from 60 to 120 micrometers, and a bulk density of at least 800 g/l and no greater than 2000 g/l when measured according to DIN EN ISO 60:2000-1. Also provided are uses of the powder, processes of making the powders, articles produced by using the powder and processes for additive manufacturing using the powder.

### TECHNICAL FIELD

The present disclosure relates generally to the field of fluoropolymer particles, more specifically to the field of sprayable powder of fluoropolymer particles suitable for additive manufacturing, in particular by laser sintering. The present disclosure further relates to a process of manufacturing such powder of fluoropolymer particles and to three-dimensional articles obtained therefrom. The present disclosure is further directed to various uses of such powder of fluoropolymer particles.

### BACKGROUND

Fluoropolymers have achieved outstanding commercial success due to their chemical and thermal inertness. They are used in a wide variety of applications in which severe operating conditions such as exposure to high temperatures and/or aggressive chemicals are encountered. Typical end use applications of the polymers include but are not limited to protective coatings, seals for engines, seals in oil-well drilling devices, and sealing elements and components for industrial equipment that operates at high temperatures or in a chemically aggressive environment.

Making such articles by additive manufacturing rather than by conventional shaping methods offer many advantages. For example, production of articles is less wasteful and complicated product designs can be realized, in particular products with design features at micrometer level.

Many additive manufacturing methods require the material to be processed to be in powdered form. It is known to prepare fluoropolymers in powdered form because in specific applications, the use of fluoropolymers in powder form is required. Fluoropolymer powders may be indeed advantageously employed for the coating of cookware articles and automotive parts and are commercially available in varies particle sizes. Such powders may be prepared, for example, by milling, typically of melt-pellets, or by spray-drying, for example as described in U.S. Pat. No. 3,953,412 (Saito et al.) and in U.S. Pat. No. 6,518,349 (Felix et al.).

However, special needs are required for fluoropolymer powders for use in additive manufacturing, in particular additive manufacturing by laser sintering, for example for avoiding or reducing structural defects in the printed articles.

Without contesting the technical advantages associated with the solutions known in the art, there is still a need for a sprayable powder of fluoropolymer particles, in particular for making articles by additive manufacturing, in particular by laser sintering. Advantageously, such powders advantageously have good or even improved free-flowing properties.

### SUMMARY

In one aspect there is provided a fluoropolymer powder for additive manufacturing of fluoropolymers having a particle size (d₅₀) in a range from 20 to 100 micrometers, preferably 30 to 70 micrometers, more preferably from 30 to 65 micrometers, most preferably from 30 to 60 micrometers and a particle size (d₉₀) in a range from 60 to 120 micrometers and a bulk density of at least 800 g/l and no greater than 2000 g/l when measured according to DIN EN ISO 60:2000-1.

In another aspect there is provided a process of making the fluoropolymer powder above comprising subjecting a fluoropolymer dispersion to spray-drying or freeze-granulation, and, optionally, sieving of the resulting powder.

In a further aspect there is provided a process for providing the powder above comprising providing a fluoropolymer powder and milling the powder, wherein the process optionally comprises sieving of the milled fluoropolymer powder.

In yet another aspect there is provided a process for providing the powder above wherein the process comprises blending two or more fluoropolymer compositions in appropriate amounts.

In a further aspect there is provided a three-dimensional article obtained by subjecting the powder above to additive manufacturing, preferably selective laser sintering (SLS).

Also provided is the use of the powder above for additive manufacturing, preferably selective laser sintering (SLS) and a process for making a three-dimensional article comprising subjecting the powder above to additive manufacturing, preferably to selective laser sintering.

### BRIEF DESCRIPTION OF THE DRAWINGS

FIG. 1 is a scanning electron microscope image of a powder obtained by a spray-drying process according to one aspect of the present disclosure.

FIG. 2 is a scanning electron microscope image depicting the inner porous structure of a fluoropolymer particle obtained by a spray-drying process according to one aspect of the present disclosure.

### DETAILED DESCRIPTION

Before any particular executions of this disclosure are explained in detail, it is to be understood that the disclosure is not limited in its application to the details of construction and the arrangement of components set forth in the following description. The invention is capable of other embodiments and of being practiced or of being carried out in various ways. Also, it is to be understood that the phraseology and terminology used herein is for the purpose of description. Contrary to the use of “consisting”, the use of “including,” “containing”, “comprising,” or “having” and variations thereof is meant to encompass the items listed thereafter and equivalents thereof as well as additional items. The use of “a” or “an” is meant to encompass “one or more”. Any numerical range recited herein describing a physical property or a concentration is intended to include all values from the lower value to the upper value of that range and including the endpoints. For example, a concentration range of from 1% to 50% is intended to be an abbreviation and to expressly disclose the values between the 1% and 50%, such as, for example, 2%, 40%, 10%, 30%, 1.5%, 3.9% and so forth.

Norms cited here refer to the norms that were in force at Jan. 1, 2018. If a norm had expired before that date, the version is referred to that was in force closest to that date.

Unless indicated otherwise the total amounts of ingredients of a composition expressed as percentage by weight of that composition add up to 100%, i.e. the total weight of the composition is always 100% by weight unless stated otherwise.

The term “perfluorinated alkyl” or “perfluoro alkyl” is used herein to describe an alkyl group where all hydrogen atoms bonded to the alkyl chain have been replaced by fluorine atoms. For example, F₃C— represents a perfluoromethyl group.

A “perfluorinated ether” is an ether of which all hydrogen atoms have been replaced by fluorine atoms. An example of a perfluorinated ether is F₃C—O—CF₃.

In the context of the present disclosure, the expression “at least partially sintered particles” is meant to express that at least part of the fluoropolymer particles surface is (thermally) sintered. The expression “substantially unsintered particles” is meant to express that no more than 5% of the surface of each fluoropolymer particle is sintered.

According to an advantageous aspect of the present disclosure, the fluoropolymer particles for use herein are at least partially sintered.

In a beneficial aspect, at least 50%, at least 60%, at least 70%, at least 80%, at least 90%, at least 95%, or even at least 99% of the surface of each fluoropolymer particle is (thermally) sintered. In a particularly advantageous aspect of the disclosure, 100% of the surface of each fluoropolymer particle for use herein is (thermally) sintered. According to this particular aspect, the fluoropolymer particles for use herein are considered as (substantially) fully sintered. According to one aspect, the present disclosure relates to a powder comprising particles of a fluoropolymer, wherein the particles have an average particle size (d₅₀) in a range from 20 to 100 micrometers, an average particle sphericity greater than 0.8 when measured according to the test method described in the experimental section, and wherein the powder has a bulk density no greater than 2000 g/l when measured according to DIN EN ISO 60:2000-1 and a powder flow time no greater than 20 seconds per 100 ml when measured according to DIN EN ISO 12086:2006-1.

In an exemplary aspect of the powder according to the disclosure, the particles for use herein have an average particle size in a range from 5 to 120 micrometers, from 10 to 120 micrometers, from 20 to 120 micrometers, from 20 to 110 micrometers, from 25 to 100 micrometers, from 25 to 90 micrometers, from 30 to 90 micrometers, or even from 30 to 80 micrometers. According to an advantageous aspect, the particles for use in the present disclosure have an average particle size (d₅₀) in a range from 20 to 95 micrometers, from 25 to 95 micrometers, from 25 to 90 micrometers, from 25 to 80 micrometers, from 25 to 70 micrometers, from 30 to 70 micrometers, from 30 to 65 micrometers, or even from 30 to 60 micrometers.

According to another advantageous aspect of the powder according to the disclosure, the particles for use herein have an average particle size (d₁₀) in a range from 3 to 40 micrometers, from 5 to 40 micrometers, from 5 to 35 micrometers, from 10 to 35 micrometers, or even from 10 to 30 micrometers.

According to still another aspect of the powder, the particles for use herein have an average particle size (d₉₀) in a range from 60 to 120 micrometers, from 65 to 120 micrometers, from 65 to 110 micrometers, from 70 to 110 micrometers, from 75 to 110 micrometers, or even from 80 to 110 micrometers.

In yet another advantageous aspect of the present disclosure, the powder comprises no greater than 15 wt %, no greater than 12 wt %, no greater than 10 wt %, no greater than 8 wt %, no greater than 6 wt %, or even no greater than 5 wt % of fluoropolymer particles having an average particle size lower than 10 micrometers.

In a preferred aspect of the present disclosure, the particles for use herein have an average particle sphericity greater than 0.85, greater than 0.90, greater than 0.95, or even greater than 0.98, when measured according to the test method described in the experimental section.

In another preferred aspect, the powder according to the present disclosure has a bulk density no greater than 1800 g/l, no greater than 1600 g/l, no greater than 1400 g/l, no greater than 1200 g/l, no greater than 1000 g/l, or even no greater than 800 g/l, when measured according to DIN EN ISO 60:2000-1.

According to a typical aspect, the powder of the disclosure has a substantially monomodal size distribution of the fluoropolymer particles. In a typical aspect still, the particles referred to herein correspond substantially to secondary particles (i.e. resulting from the agglomeration and/or aggregation of primary fluoropolymer particles). In an alternative aspect, the particles referred to herein may correspond to a mixture of primary and secondary fluoropolymer particles.

According to another aspect, the powder of the disclosure comprises a bimodal size distribution of the fluoropolymer particles, whereby substantially two fluoropolymer particle sizes are combined to form the powder.

According to a further aspect, the powder of the disclosure may comprise a bimodal size distribution of the primary fluoropolymer particles. According to still a further aspect, the powder of the disclosure may comprise a bimodal size distribution of the secondary fluoropolymer particles.

In a preferred aspect, the powder of the present disclosure is characterized by a powder flow time no greater than 20 seconds per 100 ml, no greater than 18 seconds per 100 ml, no greater than 16 seconds per 100 ml, no greater than 15 seconds per 100 ml, no greater than 14 seconds per 100 ml, no greater than 12 seconds per 100 ml, no greater than 10 seconds per 100 ml, no greater than 8 seconds per 100 ml, no greater than 6 seconds per 100 ml, no greater than 5 seconds per 100 ml, or even no greater than 4 seconds per 100 ml, when measured according to DIN EN ISO 12086:2006-1.

The powder provided with the above-described technical feature is characterized as high-flowability powder, which is particularly beneficial for usage in additive manufacturing.

Any fluoropolymers conventionally known in the art may be used in the context of the present disclosure. Suitable fluoropolymers for use herein may be easily identified by those skilled in the art, in the light of the present disclosure.

Suitable fluoropolymers for use herein include, but are not limited to, elastomeric and thermoplastic fluoropolymers.

According to an advantageous aspect of the disclosure, the fluoropolymer(s) for use herein is selected from the group consisting of perfluorinated alkyl ethers (PFA); tetrafluoroethylene (TFE) polymers; homopolymer of tetrafluoroethylene (PTFE); (co)polymers derived from tetrafluoroethylene (TFE) and optional copolymerizable modifying monomers; fluorinated ethylene propylene (co)polymers (FEP); polyvinylidene fluoride (co)polymers (PVDF); ethylene tetrafluoroethylene (co)polymers (ETFE); ethylene cholorotrifluoroethylene (co)polymers (ECTFE); fluorinated (co)polymers of ethylene and propylene (HTE); fluorinated ethylene propylene vinylidene (co)polymers (THV); and any combinations or mixtures thereof.

In a particular aspect, the fluoropolymer(s) for use in the present disclosure is selected from the group of (co)polymers derived from tetrafluoroethylene (TFE) and optional copolymerizable modifying monomers. According to this particular aspect, the copolymerizable modifying monomers may be advantageously selected from the group consisting of perfluorinated alkyl vinyl ethers (PAVE's), perfluorinated alkyl allyl ethers (PAAE's), perfluorinated methyl vinyl ether (PMVE), perfluorinated ethyl vinyl ethers (PEVE), perfluorinated (n-propyl vinyl) ether (PPVE-1), perfluorinated 2-propoxypropylvinyl ether (PPVE-2), perfluorinated 3-methoxy-n-propylvinyl ether, perfluorinated 2-methoxy-ethylvinyl ether, perfluorinated methyl allyl ether (PMAE), perfluorinated ethyl allyl ether (PEAE), perfluorinated (n-propyl allyl) ether (PPAE-1), perfluorinated 2-propoxypropyl allyl ether (PPAE-2), perfluorinated 3-methoxy-n-propyl allyl ether, perfluorinated 2-methoxy-ethyl allyl ether, hexafluoropropylene (HFP), perfluorobutyl ethylene (PFBE), chlorotrifluoroethylene (CTFE), and any combinations or mixtures thereof.

According to a more advantageous aspect of the disclosure, the fluoropolymer(s) for use herein is selected from the group consisting of perfluorinated alkyl ethers (PFA); tetrafluoroethylene (TFE) polymers; homopolymer of tetrafluoroethylene (PTFE); (co)polymers derived from tetrafluoroethylene (TFE), and optionally copolymerizable modifying monomers.

According to one preferred aspect of the disclosure, the fluoropolymer(s) for use herein is selected from the group consisting of perfluorinated alkyl ethers (PFA).

According to another preferred aspect, the fluoropolymer(s) for use in the present disclosure has an average weight molecular weight greater than 100.000 g/mol, greater than 250.000 g/mol, greater than 500.000 g/mol, greater than 750.000 g/mol, or even greater than 1.000.000 g/mol, when measured according to the test method described in the experimental section.

According to a particular aspect, the powder of the present disclosure is obtained by a process comprising the steps of:
a) providing a liquid dispersion comprising primary particles of the fluoropolymer and a liquid phase;
b) spraying the liquid dispersion through an atomizing system to form droplets comprising the primary particles of the fluoropolymer;
c) vaporizing the liquid phase from the droplets at a temperature (T₁) lower than the melting temperature of the fluoropolymer, thereby forming a powder comprising substantially unsintered particles of the fluoropolymer;
d) subjecting the powder comprising substantially unsintered particles of the fluoropolymer of step c) to a thermal treatment at a temperature (T₂) lower than the melting temperature of the fluoropolymer, wherein temperature (T₂) is greater than temperature (T₁), thereby forming a powder comprising at least partially sintered particles of the fluoropolymer; and
e) optionally, subjecting the powder comprising at least partially sintered particles of the fluoropolymer of step d) to a further thermal treatment at a temperature (T₃) greater than the melting temperature of the fluoropolymer, thereby forming a powder comprising at least partially sintered particles of the fluoropolymer.

The method of manufacturing a powder comprising particles of a fluoropolymer according to the disclosure may be performed according to the general process steps relating to spray drying of polymeric dispersion, at the exception of the specificities (in particular, the various thermal treatments) as described above.

The general procedure for spray drying of polymeric dispersion, as described e.g. in U.S. Pat. No. 6,518,349 (Felix et al.), usually involves the steps of pumping an aqueous dispersion of a polymer feed into an atomizing system, generally located at the top of a drying chamber. The liquid is typically atomized into a stream of heated gas to evaporate the water contained in the multiplicity of droplets formed, thereby producing a dry powder.

In a typical aspect, the liquid dispersion for use herein comprises water, an organic solvent, or any combinations or mixtures. Advantageously, the organic solvent for use herein is water-miscible. Suitable organic solvents for use herein are advantageously selected from the group consisting of alcohol, ethers, and any combinations or mixtures thereof.

According to one particular aspect of the disclosure, the alcohol for use in the liquid dispersion comprises methanol, ethanol, n-propanol, isopropanol, n-butanol, and any mixtures thereof.

In a beneficial aspect of the process, the liquid phase for use in the liquid dispersion comprises a combination of water and alcohols, in particular water/methanol, water/ethanol, water/propanol or water/isopropanol. Advantageously, the liquid phase for use herein comprises an aqueous composition.

According to one beneficial aspect, the liquid phase for use herein comprises a surfactant, in particular partially- or perfluorinated surfactants, nonionic surfactants, and any combinations or mixtures thereof. Suitable surfactants may advantageously stabilize the liquid dispersion comprising of primary particles of the fluoropolymer.

According to the beneficial aspect according to which the liquid phase for use herein comprises fluorinated surfactants, the fluorinated surfactant is advantageously selected from the group consisting of perfluorinated carboxylic acids, polyfluoroethylene oxide carboxylic acids, fluorinated aliphatic carboxylic acids, other fluorinated emulsifiers, and any combinations, mixtures or salts thereof. In one particular aspect, the fluorinated surfactant for use herein is selected to comprise ammonium 4,8-dioxa-3H-perfluorononanoate. Suitable fluorinated surfactants for use herein are described e.g. in U.S. Pat. No. 7,838,608 (Hintzer et al.).

According to another beneficial aspect according to which the liquid phase for use herein comprises nonionic surfactants, the nonionic surfactants advantageously comprise (co)polymers of ethylene oxide.

In a typical aspect, the liquid dispersion for use herein has a solids content in a range from 10 to 70 wt %, from 15 to 70 wt %, from 15 to 65 wt %, from 20 to 65 wt %, from 25 to 65 wt %, from 25 to 60 wt %, from 30 to 60 wt %, from 35 to 60 wt %, or even from 40 to 60 wt %.

The process of manufacturing a powder according to the disclosure comprises the step of vaporizing the liquid phase from the droplets at a temperature (T₁) lower than the melting temperature of the fluoropolymer, thereby forming a powder comprising substantially unsintered particles of the fluoropolymer.

According to a typical aspect, the temperature (T₁) is lower than the melting temperature of the fluoropolymer by at least 5° C., at least 10° C., at least 20° C., at least 30° C., at least 40° C., at least 50° C., at least 60° C., at least 70° C., at least 80° C., at least 90° C., or even at least 100° C. The temperature (T₁) is suitably chosen such that a powder comprising substantially unsintered particles of the fluoropolymer is formed. The temperature (T₁) is advantageously chosen to be insufficient to cause sintering of the fluoropolymer particles that are formed.

According to another typical aspect, the temperature (T₁) is no greater than 300° C., no greater than 295° C., no greater than 290° C., no greater than 280° C., no greater than 270° C., no greater than 260° C., no greater than 250° C., no greater than 240° C., no greater than 230° C., no greater than 220° C., no greater than 210° C., or even no greater than 200° C.

According to still another typical aspect, the temperature (T₁) is in a range from 120 to 290° C., from 120 to 280° C., from 140 to 260° C., from 150 to 240° C., from 160 to 220° C., from 160 to 200° C., or even from 180 to 200° C.

The process of manufacturing a powder according to the disclosure further comprises the step of subjecting the powder comprising substantially unsintered particles to a thermal treatment at a temperature (T₂) lower than the melting temperature of the fluoropolymer, wherein temperature (T₂) is greater than temperature (T₁), thereby forming a powder comprising at least partially sintered particles of the fluoropolymer.

According to a typical aspect, the temperature (T₂) is lower than the melting temperature of the fluoropolymer by no greater than 30° C., no greater than 25° C., no greater than 20° C., no greater than 15° C., no greater than 10° C., or even no greater than 5° C.

According to another typical aspect, the temperature (T₂) is in a range from 265 to 300° C., from 270 to 300° C., from 270 to 295° C., from 275 to 295° C., from 280 to 295° C., or even from 285 to 295° C.

The process of manufacturing a powder according to the disclosure may optionally comprise the further step of subjecting the powder comprising at least partially sintered particles of the fluoropolymer to a further thermal treatment at a temperature (T₃) greater than the melting temperature of the fluoropolymer, thereby forming a (densified) powder comprising at least partially sintered particles of the fluoropolymer.

According to still another typical aspect, the temperature (T₃) is greater than 210° C., greater than 220° C., greater than 230° C., greater than 240° C., greater than 250° C., greater than 260° C., greater than 270° C., greater than 280° C., greater than 290° C., greater than 295° C., greater than 300° C., greater than 305° C., or even no greater than 310° C.

The various thermal treatments as described above may be performed by any methods conventionally known in the art of processing polymeric microparticles.

In one exemplary aspect, the various steps of subjecting the powder to a thermal treatment are performed by exposing the powder to a heated gas.

According to the present disclosure, the optional step of subjecting the powder comprising at least partially sintered particles of the fluoropolymer to a further thermal treatment at a temperature (T₃) greater than the melting temperature of the fluoropolymer, may advantageously correspond to a so-called densification step.

The process of manufacturing a powder according to the disclosure may optionally comprise the further step of treating the powder comprising at least partially sintered particles of the fluoropolymer resulting from step d) or e) with a liquid phase comprising water, an organic solvent, or any combinations or mixtures.

This optional step may advantageously help removing any unwanted additives, in particular surfactants, resulting from the liquid dispersion used for spray drying.

Accordingly, the liquid phase for use in this optional step is advantageously selected to be as described above.

In an advantageous aspect, the process according to the disclosure is free of any powder densification steps. More advantageously, the process according to the disclosure is free of any mechanical densification steps, in particular free of any mechanical compaction steps.

In another advantageous aspect, the process according to the disclosure is free of any thermal densification steps. More advantageously, the process according to the disclosure is free of any thermal densification steps of the powder performed at a temperature lower than the melting temperature of the fluoropolymer.

According to another aspect, the present disclosure is directed to a process of manufacturing a three-dimensional article, comprising the step of using a powder as described above.

In the context of the present disclosure, it has been indeed surprisingly found that a fluoropolymer powder as described above, is outstandingly suitable for additive manufacturing, in particular by laser sintering.

All the particular and advantageous aspects relating to the fluoropolymer powder as described above are fully applicable to the process of manufacturing a three-dimensional article.

In an advantageous aspect, the process of manufacturing a three-dimensional article further comprises the step of sintering a powder as described above, in particular by selective laser sintering.

Processes for manufacturing three-dimensional articles, and in particular by laser sintering of polymer powders are known in the art.

According to still another aspect of the present disclosure, it is provided a three-dimensional article obtained by sintering a powder as described above, in particular a three-dimensional article obtained by selective laser sintering of a powder as described above.

All the particular and advantageous aspects relating to the fluoropolymer powder as described above are fully applicable to the three-dimensional article obtained by sintering said powder.

According to still another aspect, the present disclosure relates to the use of a powder as described above for the manufacturing of a three-dimensional article. Advantageously, the manufacturing of the three-dimensional article comprises the step of sintering the powder, in particular by selective laser sintering.

### LIST OF ILLUSTRATIVE EMBODIMENTS

The following list provides some illustrative embodiments of the present disclosure. The list is meant for illustrative purposes and there is no intention to limit the disclosure to the specific embodiments of the following list.

First illustrative embodiment: A powder for additive manufacturing comprising particles of a fluoropolymer, wherein the particles have an average particle size (d₅₀) in a range from 20 to 100 micrometers, an average particle sphericity greater than 0.8 when measured according to the test method described in the experimental section, and wherein the powder has a bulk density no greater than 2000 g/l when measured according to DIN EN ISO 60:2000-1 and a powder flow time no greater than 20 seconds per 100 ml when measured according to DIN EN ISO 12086:2006-1.

Second illustrative embodiment: The powder according to the first illustrative embodiment, wherein the particles of a fluoropolymer are at least partially sintered.

Third illustrative embodiment: The powder according to any of the first or second illustrative embodiment, wherein the particles have an average particle size (d₁₀) in a range from 3 to 40 micrometers, from 5 to 40 micrometers, from 5 to 35 micrometers, from 10 to 35 micrometers, or even from 10 to 30 micrometers.

Fourth illustrative embodiment: The powder according to any of the preceding illustrative embodiments, wherein the particles have an average particle sphericity greater than 0.85, greater than 0.90, greater than 0.95, or even greater than 0.98, when measured according to the test method described in the experimental section.

Fifth illustrative embodiment: The powder according to any of the preceding illustrative embodiments, which has a bulk density no greater than 1800 g/l, no greater than 1600 g/l, no greater than 1400 g/l, no greater than 1200 g/l, no greater than 1000 g/l, or even no greater than 800 g/l, when measured according to DIN EN ISO 60:2000-1.

Sixth illustrative embodiment: The powder according to any of the preceding illustrative embodiments, which has a powder flow time no greater than 20 seconds per 100 ml, no greater than 18 seconds per 100 ml, no greater than 16 seconds per 100 ml, no greater than 15 seconds per 100 ml, no greater than 14 seconds per 100 ml, no greater than 12 seconds per 100 ml, no greater than 10 seconds per 100 ml, no greater than 8 seconds per 100 ml, no greater than 6 seconds per 100 ml, no greater than 5 seconds per 100 ml, or even no greater than 4 seconds per 100 ml, when measured according to DIN EN ISO 12086:2006-1.

Seventh illustrative embodiment: The powder according to any of the preceding illustrative embodiments, wherein the fluoropolymer is selected from the group consisting of perfluorinated alkyl ethers (PFA); tetrafluoroethylene (TFE) polymers; homopolymer of tetrafluoroethylene (PTFE); (co)polymers derived from tetrafluoroethylene (TFE) and optional copolymerizable modifying monomers; fluorinated ethylene propylene (co)polymers (FEP); polyvinylidene fluoride (co)polymers (PVDF); ethylene tetrafluoroethylene (co)polymers (ETFE); ethylene cholorotrifluoroethylene (co)polymers (ECTFE); fluorinated (co)polymers of ethylene and propylene (HTE); fluorinated ethylene propylene vinylidene (co)polymers (THV); and any combinations or mixtures thereof.

Eighth illustrative embodiments: The powder according to any of the preceding illustrative embodiments, which is obtained by a process comprising the steps of:
a) providing a liquid dispersion comprising primary particles of the fluoropolymer and a liquid phase;
b) spraying the liquid dispersion through an atomizing system to form droplets comprising the primary particles of the fluoropolymer;
c) vaporizing the liquid phase from the droplets at a temperature (T₁) lower than the melting temperature of the fluoropolymer, thereby forming a powder comprising substantially unsintered particles of the fluoropolymer;
d) subjecting the powder comprising substantially unsintered particles of the fluoropolymer of step c) to a thermal treatment at a temperature (T₂) lower than the melting temperature of the fluoropolymer, wherein temperature (T₂) is greater than temperature (T₁), thereby forming a powder comprising at least partially sintered particles of the fluoropolymer; and
e) optionally, subjecting the powder comprising at least partially sintered particles of the fluoropolymer of step d) to a further thermal treatment at a temperature (T₃) greater than the melting temperature of the fluoropolymer, thereby forming a densified powder comprising at least partially sintered particles of the fluoropolymer.

Ninth illustrative embodiment: The process of manufacturing a powder comprising at least partially sintered particles of a fluoropolymer, wherein the process comprises the steps of:
a) providing a liquid dispersion comprising primary particles of the fluoropolymer and a liquid phase;
b) spraying the liquid dispersion through an atomizing system to form droplets comprising the primary particles of the fluoropolymer;
c) vaporizing the liquid phase from the droplets at a temperature (T₁) lower than the melting temperature of the fluoropolymer, thereby forming a powder comprising substantially unsintered particles of the fluoropolymer;
d) subjecting the powder comprising substantially unsintered particles of the fluoropolymer of step c) to a thermal treatment at a temperature (T₂) lower than the melting temperature of the fluoropolymer, wherein temperature (T₂) is greater than temperature (T₁), thereby forming a powder comprising at least partially sintered particles of the fluoropolymer; and
e) optionally, subjecting the powder comprising at least partially sintered particles of the fluoropolymer of step d) to a further thermal treatment at a temperature (T₃) greater than the melting temperature of the fluoropolymer, thereby forming a densified powder comprising at least partially sintered particles of the fluoropolymer.

Tenth illustrative embodiment: The process according to the ninth illustrative embodiment, wherein the liquid phase comprises a surfactant, in particular partially- or perfluorinated surfactants, nonionic surfactants, and any combinations or mixtures thereof.

Eleventh illustrative embodiment: The process according to any of illustrative embodiments 9 or 10, wherein the temperature (T₁) is lower than the melting temperature of the fluoropolymer by at least 5° C., at least 10° C., at least 20° C., at least 30° C., at least 40° C., at least 50° C., at least 60° C., at least 70° C., at least 80° C., at least 90° C., or even at least 100° C.

Twelfth illustrative embodiment: The process according to any of the ninth to eleventh illustrative embodiments, wherein the temperature (T₂) is lower than the melting temperature of the fluoropolymer by no greater than 30° C., no greater than 25° C., no greater than 20° C., no greater than 15° C., no greater than 10° C., or even no greater than 5° C.

Thirteenth illustrative embodiment: The process according to any of the ninth to twelfth illustrative embodiment, which further comprises the step of treating the powder comprising at least partially sintered particles of the fluoropolymer resulting from step d) or e) with a liquid phase comprising water, an organic solvent, or any combinations or mixtures.

Fourteenth illustrative embodiment: A three-dimensional article obtained by sintering a powder according to any of the first to the eighth illustrative embodiments, in particular by selective laser sintering.

Fifteenth illustrative embodiment: Use of a powder according to any of the first to the eighth illustrative embodiment for laser sintering, in particular for selective laser sintering.

In the following are provided various preferred embodiments of the present disclosure.

### Preferred Aspects of the Present Disclosure

In the following section some preferred embodiments of the present disclosure are described for illustrative purposes.

According to a first preferred embodiment there is provided a fluoropolymer powder suitable for additive manufacturing. The powder has a particle size (d₅₀) in a range from 20 to 100 micrometers, preferably 30 to 70 micrometers, more preferably from 30 to 65 micrometers, most preferably from 30 to 60 micrometers and a particle size (d₉₀) in a range from 60 to 120 micrometers. The powder may advantageously have a bulk density of at least 500 g/l, preferably at least 600 g/l, most preferably at least 800 g/l. The bulk density may be less than 2000 g/l (measured according to DIN EN ISO 60:2000-1). Such powders have been found to be nicely spreadable and provide smooth and homogenous powder beds with little or no surface defects. This is useful for additive processing of powdered materials because three-dimensional articles with no or fewer surface defects can be prepared from powder beds with few or no surface defects. The fluoropolymer powders may be used to produce fluoropolymer articles by additive manufacturing, in particular selective laser sintering. The powder is particularly suitable for producing fluoropolymer articles from thermoplastic fluoropolymers with low melt flow rates, for example flow rates of from about 0.1 to 25 g/10 min (MFI 372/5). Such polymers have been found difficult to process by additive manufacturing. Fluoropolymers with high melt flow rates may also be processed by using the powder. It has been found that finer powders, e.g. powders with a smaller particle population and coarser powders with a larger particle size produce less suitable powder beds of the respective fluoropolymers.

The fluoropolymer powder for additive manufacturing of fluoropolymers according to the preferred embodiment has a particle size (d₅₀) in a range from 20 to 100 micrometers, preferably 30 to 70 micrometers, more preferably from 30 to 65 micrometers, most preferably from 30 to 60 micrometers. The d50 value indicates that 50% of the particles are smaller and 50% of the particles are larger than this value. According to a preferred embodiment the fluoropolymer powder additionally has a particle size (d₉₀) in a range from 60 to 120 micrometers, preferably from 65 to 120 micrometers, more preferably from 65 to 110 micrometers. The d₉₀ (or “D90”) value indicates that 90% of the particles are smaller than this value. According to another advantageous aspect of the powder according to the preferred embodiment the powder additionally has a particle size (d₁₀) in a range from 3 to 40 micrometers, from 5 to 40 micrometers, from 5 to 35 micrometers, from 10 to 35 micrometers, or even from 10 to 30 micrometers. The d₁₀ (or “D10”) value indicates that 10% of the particles are smaller than this value.

In a preferred embodiment of the powder the particles have a particle size of less than 200 μm, preferably less than 150 μm or 120 μm or less (e.g. d₁₀₀ is <200 μm, preferably d₁₀₀ is <150 μm).

According to another preferred embodiment the fluoropolymer powder has a bulk density of at least 500 g/l, preferably at least 600 g/l and most preferably at least 800 g/l and no greater than 2000 g/l when measured according to DIN EN ISO 60:2000-1. Typically, the powder the powder has a bulk density of between 500 g/l and 1800 g/l, preferably between 800 g/l up to 1800 g/l, between 800 g/l up to 1600 g/l, between 800 g/l up to 1400 g/l, preferably between 800 g/l and up to 1000 g/l.

According to one embodiment, the powders may have a flow time no greater than 20 seconds per 100 ml when measured according to DIN EN ISO 12086:2006-1, for example a flow time of from 4 to 20 seconds per 100 ml, preferably between 5 and 10 seconds per 100 ml, preferably such powders are obtained by a process involving spray-drying or freeze-granulation

In one embodiment of the present disclosure, the fluoropolymer powder of the present disclosure) may have an overall melt flow rate of at least 0.1 g/10 min at 372° C. using a 5 kg load (MFI 372/5 of 0.1 g/10 min or <0.1 g/10 min), for example an MFI (372/5) of from 1 to 50 g/10 min, preferably between 1.5 and 21 g/10 min, more preferably between 2.5 and 18 g/10 min.

In another embodiment of the present disclosure, the fluoropolymer powder has an overall MFI (297° C./5 kg) from 0.5 g/10 min to 60 g/10 min, preferred 1 to 45, most preferably 2 to 32 g/10 min. This is typically the case when the powder comprises only (or mainly i.e. >50% by weight based on the weight of the powder) of fluoropolymers selected from partially fluorinated polymers containing units derived from ethene, for example polymers of the type ETFE and HTE.

In yet another embodiment of the present disclosure the fluoropolymer powder has an overall MFI at 265° C./5 kg from 0.5 to 100 g/10 min, preferably from 1 to 50 g/10 min, most preferably from 1.5 to 30 g/10 min. This is typically the case when the powder comprises only (or mainly i.e. >50% by weight based on the weight of the powder) fluoropolymers selected from partially fluorinated polymers containing units derived from vinylidene fluoride, for example polymers of the type THV or PVDF.

The fluoropolymer powder of the present disclosure may have at least one melting point within the range of from about 110° C. to about 320° C., preferably from about 140° C. to 310° C., more preferably from 250° C. to 310° C.

In one embodiment of the present disclosure the fluoropolymer powder of the present disclosure will have a specific gravity of from 1.6 g/cm³ to 2.2 g/cm³, preferably from 1.90 to 2.18 g/cm³, more preferably from 1.95 to 2.16 g/cm³ when measured according to (DIN EN ISO 12086). In one embodiment the powder will have a specific density when measured according to DIN EN ISO 12086 of between 1.75 to 2.18 g/cm³, for example between 1.80 and 2.16 g/cm³.

The fluoropolymer powder of the present disclosure comprises fluoropolymer particles of one or more than one fluoropolymer. The fluoropolymer particles may have a particle size (d₅₀) in a range from 20 to 100 micrometers, preferably 30 to 70 micrometers, more preferably from 30 to 65 micrometers, most preferably from 30 to 60 micrometers and a particle size (d₉₀) in a range from 60 to 120 micrometers. The fluoropolymer particles may additionally have a particle size (d₁₀) in a range from 3 to 40 micrometers, from 5 to 40 micrometers, from 5 to 35 micrometers, from 10 to 35 micrometers, or even from 10 to 30 micrometers.

Preferably the fluoropolymers are selected from fluoropolymers having narrow melting peaks and/or narrow crystallisation peaks that do not overlap with each other or do not substantially overlap.

The fluoropolymers for use in the present disclosure may have a melt flow index (MFI) of at least 0.1 g/10 min at 372° C. using a 5 kg load (MFI 372/5 of 0.1 g/10 min or <0.1 g/10 min). Fluoropolymers with an MFI (372/5) of less than 0.1 g/10 min are considered not melt-processable. Homopolymers or TFE (i.e. PTFE) and TFE-comonomers with a comonomer content of up to 1% by weight are typically not melt-processable. The fluoropolymers for use in the present disclosure preferably have an MFI (372/5) of from 1 to 50 g/10 min, more preferably from 1.5 to 21, most preferably from 2.5 to 18 (all in 1 g/10 min).

The fluoropolymers for use in the present disclosure may have a melting point of from about 110° C. to about 320° C., preferably from 250° C. to 310° C. The fluoropolymers for use in the present disclosure may have a tensile strength of at least 5 MPa or at least 10 MPa, for example between 21 and 60 MPa. The fluoropolymers for use in the present disclosure may have an elongation at break of at least 20% or at least 100% or even at least 200%, for example between 250% and 400%. The fluoropolymers for use in the present disclosure may have a flexural modulus of at least 520, in some embodiments between 520 and 600 MPa (ASTM D 790; injection molded bars, 127 mm by 12.7 mm by 3.2 mm, 23° C.). The fluoropolymers for use in the present disclosure may have a specific gravity (DIN EN ISO 12086) of from 1.60 g/cm³ to 2.20 g/cm³, preferably from 1.90 to 2.18 g/cm³, more preferably from 1.95 to 2.16 g/cm³. The fluoropolymers for use in the present disclosure may be selected from tetrafluoroethene copolymers as described herein that may have a hardness (shore D; DIN EN ISO 868) of from 40 to 80, preferably 50 to 70.

In one embodiment the fluoropolymer powder comprises one or more fluoropolymers selected from the group of partially fluorinated polymers, for example, e. a polymer prepared with monomers having C—F and C—H bonds and or with monomers having no C—F bonds but only C—H bonds. Examples of such comonomers include ethene (E), propene (P), vinylidene fluoride (VDF) and vinyl fluoride.

In one embodiment the fluoropolymer is a polymer containing units derived from vinylidene fluoride (VDF), for example from 70% by weight up to 100% by weight of units derived from VDF. Such a polymer is a partially fluorinated polymer.

However, more preferably, the fluoropolymer is a copolymer of tetrafluoroethene (TFE) and one or more than one polymerizable comonomers. Suitable copolymerizable monomers include the monomers described above and in particular include perflurinated alpha-olefins, preferably those with 3 to 12 carbon atoms and more preferably hexafluoropropene (HFP); chlorotrifluoroethene (CTFE), perfluorinated vinyl ether (PAVE), perfluorinated allyl ether (PAAE), perfluorinated allyl vinyl ether, perfluorinated bis-vinyl ether, perfluorinated bis-allyl ether and combinations thereof.

PAVE's and PAAE's correspond to the general formula (I):

CF₂═CF—(CF₂)ₙ—O-Rf (I).

In formula (I) n represents either 0 or 1. In case n is 0, the compound is a vinyl ether. In case n is 1, the compound is an allyl ether. Rf represents a linear or branched, cyclic or acyclic perfluorinated alkyl residue. The alkyl residue may contain one catenary oxygen atom or may contain more than one catenary oxygen (ether) atom. Rf may contain up to 12, preferably, up to 6 carbon atoms, such as 1, 2, 3, 4, 5 and 6 carbon atoms. Preferably the residue Rf is linear or branched but not cyclic. Specific examples include perfluorinated methyl vinyl ether (PMVE), perfluorinated ethyl vinyl ether (PEVE), perfluorinated (n-propyl vinyl) ether (PPVE-1), perfluorinated 2-propoxypropylvinyl ether (PPVE-2), perfluorinated 3-methoxy-n-propylvinyl ether, perfluorinated 2-methoxy-ethylvinyl ether; perfluorinated methyl allyl ether (PMAE), perfluorinated ethyl allyl ether (PEAE), perfluorinated (n-propyl allyl) ether (PPAE-1), perfluorinated 2-propoxypropyl allyl ether (PPAE-2), perfluorinated 3-methoxy-n-propyl allyl ether, perfluorinated 2-methoxy-ethyl allyl ether and any combinations or mixtures thereof.

Further examples of Rf include but are not limited to: —(CF₂)ᵣ₁—O—C₃F₇, —(CF₂)ᵣ₂—O—C₂F₅, —(CF₂)ᵣ₃—O—CF₃, —(CF₂O)ₛ₁—C₃F₇, —(CF₂—O)ₛ₂—C₂F₅, —(CF₂—O)ₛ₃—CF₃, —(CF₂CF₂—O)ₜ₁—C₃F₇, —(CF₂CF₂—O)ₜ₂—C₂F₅, —(CF₂CF₂—O)ₜ₃—CF₃,

wherein r1 and s1 represent 1, 2, 3, 4, or 5, r2 and s2 represent 1, 2, 3, 4, 5 or 6, r3 and s3 represent 1, 2, 3, 4, 5, 6 or 7; t1 represents 1 or 2; t2 and t3 represent 1, 2 or 3.

Allyl vinyl ether, bis-vinyl ether and bis-allyl ether correspond to the general formula (II):

CF₂═CF—(CF₂)ₙ—O-Rf′-O—(CF₂)ₘ—CF═CF₂ (II).

In formula (II) n and m represent, independently from each other, either 1 or 0. Rf′ represents a linear, branched, cyclic or acyclic perfluorinated alkylene unit that may or may not contain one or more catenary oxygen atoms. Rf′ may have up to 12, preferably up to 8 carbon atoms. Typical examples of Rf′ include linear or branched alkylenes containing one or more —(CF₂O)— or —(CF₂CF₂—O)— units. Further examples for Rf′ include but are not limited to —(CF₂)ᵤ, —(CF₂)ᵥ—CF(CF₃)—(CF₂)_{q}—, —(CF₂)ᵥ—CF(C₂F₅)—(CF₂)_{q}—, wherein u represents 1, 2, 3, 4, 5, 6, 7 or 8;
v represents 0, 1, 2, 3, 4, 5, 6; q represents 0, 1, 2, 3, 4, 5, 6, with the proviso that v+q is 6 or less.

Perfluorinated comonomers as described above are either commercially available, for example from Anles Ltd. St. Peterburg, Russia or can be prepared according to methods described in EP 1 240 125 to Worm et al., or EP 0 130 052 to Uschold et al. or in Modern Fluoropolymers, J. Scheirs, Wiley 1997, p 376-378.

The fluoropolymers of the present disclosure preferably are copolymers of tetrafluoroethene and one or more comonomers and the comonomer content is greater than 1% by weight and may be up to 50% by weight. Such polymers may be partially fluorinated or perfluorinated.

In one embodiment the powder according to the present disclosure contains one or more THV polymers, and preferably no other fluoropolymer. A THV polymer is a fluoropolymer with units derived from TFE, hexafluoropropene (HFP) and vinylidene fluoride (VDF). Such a polymer has a partially fluorinated backbone. Preferably, the fluoropolymer comprises from at least 50% by weight of units derived from TFE, from about 10% up to about 40% by weight of units derived from vinylidenefluoride (VDF) and from about 10 to about 40% by weight of units derived from hexafluoropropene (HFP) and from 0 to about 10% by weight of further comonomers (weight percentages are based on the total weight of the polymer which is 100% by weight. Such polymers include polymers known in the art as THV's. Commercial THV grades may be used, for example THV 221GZ, THV 221AZ, THV415GZ, THV 500GZ, THV 610GZ all available from Dyneon GmbH, Germany. In one embodiment of the present disclosure the fluoropolymer powder comprises one or more THV fluoropolymer having an MFI of MFI (265° C./5 kg) from 0.5 to 100 g/10 min, preferably from 1 to 50 g/10 min, most preferably from 1.5 to 30 g/10 min.

In one embodiment of the present disclosure the fluoropolymer powder comprises one or more copolymers of TFE and E (ETFE) or a copolymer of TFE, HFP and E (HTE). Such polymers are commercially available, for example under the trade designation ETFE 6218Z, ETFE 6235Z, HTE 1705 from Dyneon GmbH. In one embodiment of the present disclosure the fluoropolymer powder comprises one or more ETFE or HTE polymer having an MFI of MFI (297° C./5 kg) from 0.5 g/10 min to 60 g/10 min, preferred 1 to 45, most preferably 2 to 32 g/10 min.

In a preferred embodiment the fluoropolymer is a perfluorinated polymer, i.e. it has been prepared by using only perfluorinated monomers.

In another preferred embodiment the fluoropolymer of the powder according to the present disclosure comprises one or more FEP polymers, and preferably no other types of fluoropolymers. An FEP polymer is a TFE-copolymer that contains units derived from TFE and HFP and one or more units derived from one or more PAVE, one or more PAAE, and combinations thereof. Preferably, the polymer contains a perfluorinated backbone. Preferably, the polymer contains from of at least 50% by weight preferably at least 66% by weight or even at least 75% by weight based on the weight of the polymer of units derived from TFE. The total amount of units derived from PAVEs and PAAEs is in a range from 0.2 to 12 percent by weight based on the weight of the polymer (total weight of the polymer being 100% by weight), and in some embodiments they may be present in a range from 0.5 to 6% by weight based on the total weight of the copolymer. The polymer further contains units derived from HFP in a range from 5 wt. % to 22 wt. %, preferably in a range from 10 wt. % to 17 wt. %, more preferably in a range from 11 wt. % to 16 wt. %, or most preferably in a range from 11.5 wt. % to 15.8 wt. %. The polymer may contain from 0 to 10% by weight of other comonomers, preferably perfluorinated comonomers. (The weight percentages are based on the total weight of the copolymer with the total weight of the copolymer being 100% by weight). Such polymers include polymers known in the art as FEP's. Commercial FEP grades may be used, for example the FEP 6301 series, FEP 6303 series, FEP 6305 series, FEP FLEX6307 series, FEP6322 series, FEP 6322HTZ, FEP FLEX6338Z all available from Dyneon GmbH Germany. In one embodiment of the present disclosure the fluoropolymer powder comprises one or more FEP polymers having a melt flow rate of at least 0.1 g/10 min at 372° C. using a 5 kg load (MFI 372/5 of 0.1 g/10 min or <0.1 g/10 min), for example an MFI (372/5) of from 1 to 50 g/10 min, preferably between 1.5 and 21 g/10 min, more preferably between 2.5 and 18 g/10 min.

In a particularly preferred embodiment of the present disclosure the powder comprises one or more PFA fluoropolymer, and preferably no other type of fluoropolymer. A PFA is a TFE-copolymer that contains units derived from TFE and one or more PAVE and/or one or more PAAE. Typically, the copolymer comprises from 75% by weight up to 99% by weight units derived from tetrafluoroethene and from 1.5% by weight up to 25% by weight of units derived from one or more PAVE and/or one or more PAAE. The polymer may further contain from 0 to 4% by weight of other comonomers. The weight percentages are based on the total weight of the polymer which is 100% by weight. Preferably, the TFE-based copolymers contain from 90 to 98% by weight of units derived from TFE and from 1.5 to 10% of units derived from one or more PAAE and from PMVE and from 0-5% of units derived from one or more other comonomers, preferably perfluorinated comonomers. The amounts are selected to give 100% by weight in the polymer. Preferably, the polymer has a perfluorinated backbone, i.e. the backbone is derived only from perfluorinated monomers. Such polymers include polymers known in the art as PFA's. Commercial PFA's may be used, for example the PFA 6502 series, the PFA6503 series, the PFA 6505 series, the 6515 series, the PFA 6525 series, the PFA 80502 series and the PFA6900 series, all available from Dyneon GmbH. In one embodiment of the present disclosure, the fluoropolymer powder contains one or more PFA polymers having a melt flow rate of at least 0.1 g/10 min at 372° C. using a 5 kg load (MFI 372/5 of 0.1 g/10 min or <0.1 g/10 min), for example an MFI (372/5) of from 1 to 50 g/10 min, preferably between 1.5 and 21 g/10 min, more preferably between 2.5 and 18 g/10 min.

The fluoropolymers for use in the present disclosure can be prepared by known methods, for example by suspension polymerization or emulsion polymerization.

In a suspension polymerisation the reaction mixture coagulates and settles as soon as stirring of the reaction mixture is discontinued. Suspension polymerisations are typically carried out in the absence of emulsifiers. Usually vigorous stirring is required. Fluoropolymer particles obtained by suspension polymerisation are larger than the particles obtained by emulsion polymerisation.

In aqueous emulsion polymerisations the polymerisation is carried out in a way that stable dispersions are obtained. The dispersions remain stable after stirring of the reaction mixture has stopped for at least 2 hours, or at least 12 hours or at least 24 hours. Typically, fluorinated emulsifiers are employed in the aqueous emulsion polymerisation but methods are also known where no fluorinated emulsifiers have to be used. When used, a fluorinated emulsifier is typically used in an amount of 0.01% by weight to 1% by weight based on solids (polymer content) to be achieved. Suitable emulsifiers include any fluorinated emulsifier commonly employed in aqueous emulsion polymerization. Particularly preferred emulsifiers are those that correspond to the general formula:

Y—R_{f}—Z-M (III)

wherein Y represents hydrogen, Cl or F; R_{f} represents a linear or branched perfluorinated alkylene having 4 to 10 carbon atoms; Z represents COO⁻ or SO₃⁻ and M represents a cation like an alkali metal ion, an ammonium ion or H⁺. Exemplary emulsifiers include: ammonium salts of perfluorinated alkanoic acids, such as perfluorooctanoic acid and perfluorooctane sulphonic acid.

More preferable for use in the preparation of the polymers described herein are emulsifiers of the general formula:

[R_{f}—O-L-COO⁻]ᵢXᵢ⁺ (IV)

wherein L represents a linear or branched partially or fully fluorinated alkylene group or an aliphatic hydrocarbon group, R_{f} represents a linear or branched, partially or fully fluorinated aliphatic group or a linear or branched partially or fully fluorinated group interrupted with one or more oxygen atoms, Xᵢ⁺ represents a cation having the valence i and i is 1, 2 and 3. In case the emulsifier contains partially fluorinated aliphatic group it is referred to as a partially fluorinated emulsifier. Preferably, the molecular weight of the emulsifier is less than 1,000 g/mole.
Specific examples of emulsifiers include those described in, for example, US Pat. Publ. 2007/0015937 (Hintzer et al.).

Other emulsifiers include fluorosurfactants that are not carboxylic acids, such as for example, sulfinates or perfluoroaliphatic sulfinates or sulfonates. The sulfinate may have a formula Rf-SO₂M, where Rf is a perfluoroalkyl group or a perfluoroalkoxy group. The sulfinate may also have the formula Rf′-(SO₂M)n where Rf′ is a polyvalent, preferably divalent, perfluoro radical and n is an integer from 2-4, preferably 2. Preferably the perfluoro radical is a perfluoroalkylene radical. Generally, Rf and Rf′ have 1 to 20 carbon atoms, preferably 4 to 10 carbon atoms. M is a cation having a valence of 1 (e.g. H+, Na+, K+, NH₄+, etc.). Specific examples of such fluorosurfactants include, but are not limited to, C₄F₉—SO₂Na; C₆F₁₃—SO₂Na; C₈F₁₇—SO₂Na; C₆F₁₂—(SO₂Na)₂; and C₃F₇—O—CF₂CF₂—SO₂Na.

The emulsifiers may be used alone or in combination as a mixture of two or more of them. The amount of the emulsifier is well below the critical micelle concentration, generally within a range of from 250 to 5,000 ppm (parts per million), preferably 250 to 2000 ppm, more preferably 300 to 1000 ppm, based on the mass of water to be used. Within this range, the stability of the aqueous emulsion should be sufficient. In order to further improve the stability of the aqueous emulsion, it may be preferred to add one or more emulsifiers during or after the polymerization. The amount of emulsifier used may influence the shape of the polymer particles formed. Higher amounts of emulsifiers, in particular amounts above the cmc may lead to the generation of elongated particles like rod-shaped or ribbon-shaped particles. Lower amounts of emulsifiers may lead to spheroidal or spherical particles.

The emulsifier may be added alone or in combination with other liquids, for example a polyether or a (per)fluorinated hydrocarbon, or as a microemulsion with a fluorinated liquid, such as described in U.S. Publ. No. 2008/0015304 (Hintzer et al.), WO Publ. No. 2008/073251 (Hintzer et al.), and EP Pat. No. 1245596 (Kaulbach et al.). Microemulsions are transparent emulsions that are thermodynamically stable (stable for longer than 24 hours) and have droplet sizes from 10 nm to a maximum of 100 nm. Large quantities of fluorinated emulsifiers are used to prepare these microemulsions.

The polymerization may be initiated with a free radical initiator or a redox-type initiator. Suitable initiators include organic as well as inorganic initiators, although the latter are generally preferred. Exemplary organic initiators include: organic peroxide such as bissuccinic acid peroxide, bisglutaric acid peroxide, or tert-butyl hydroperoxide. Exemplary inorganic initiators include: ammonium-alkali- or earth alkali salts of persulfates, permanganic or manganic acids, with potassium permanganate preferred. A persulfate initiator, e.g. ammonium persulfate (APS), may be used on its own or may be used in combination with a reducing agent. Suitable reducing agents include bisulfites such as for example ammonium bisulfate or sodium metabisulfite, thiosulfates such as for example ammonium, potassium or sodium thiosulfate, hydrazines, azodicarboxylates and azodicarboxyldiamide (ADA). Further reducing agents that may be used include sodium formaldehyde sulfoxylate or fluoroalkyl sulfinates. The reducing agent typically reduces the half-life time of the persulfate initiator. Additionally, a metal salt catalyst such as for example copper, iron, or silver salts may be added.

The amount of the polymerization initiator may suitably be selected, but it is usually preferably from 2 to 600 ppm, based on the mass of water used in the polymerisation. The amount of the polymerization initiator can be used to adjust the MFI of the tetrafluoroethene copolymers. If small amounts of initiator are used a low MFI will be obtained. The MFI can also, or additionally, be adjusted by using a chain transfer agent. Typical chain transfer agents include ethane, propane, butane, alcohols such as ethanol or methanol or ethers like but not limited to dimethyl ether, tert butyl ether, methyl tert butyl ether. The amount and the type of perfluorinated comomonomer influences the melting point of the resulting polymer.

The aqueous emulsion polymerization system may further comprise auxiliaries, such as buffers, and complex-formers. It is preferred to keep the amount of auxiliaries as low as possible to ensure a higher colloidal stability of the polymer latex. The aqueous emulsion polymerization may further comprise additional comonomers if desired.

The polymerization may run to produce homogeneous or heterogeneous polymers and the polymerization may, for example, be run to produce core-shell polymers or block polymers or random polymers, monomodal polymers or multimodal polymers. Polymerization of TFE using seed particles is described, for example, in U.S. Pat. No. 4,391,940 (Kuhls et al.) or WO03/059992 A1.

The aqueous emulsion polymerization, whether done with or without seed particles, will preferably be conducted at a temperature of at least 10° C., 25° C., 50° C., 75° C., or even 100° C.; at most 70° C., 80° C., 90° C., 100° C., 110° C., 120° C., or even 150° C. The polymerization will preferably be conducted at a pressure of at least 0.5, 1.0, 1.5, 1.75, 2.0, or even 2.5 MPa (megaPascals); at most 2.25, 2.5, 3.0, 3.5, 3.75, 4.0, or even 4.5 MPa.

Usually the aqueous emulsion polymerization is carried out by mildly stirring the aqueous polymerization mixture. The stirring conditions are controlled so that the polymer particles formed in the aqueous dispersion will not coagulate. The aqueous emulsion of the present disclosure may be carried out in a vertical kettle (or autoclave) or in a horizontal kettle. Paddle or impeller agitators may be used.

The aqueous emulsion polymerization usually is carried out until the concentration of the polymer particles in the aqueous emulsion is at least 15, 20, 25, or even 30% by weight; at most 20, 30, 35, 40, or even 50% by weight (also referred to a solid content).

In the resulting dispersion, the average particle size of the polymer particles (i.e., primary particles) is at least 150, 200, or even 250 nm; at most 250, 275, 300, or even 450 nm.

After the conclusion of the polymerization reaction, the dispersions may be treated by anion exchange to remove the emulsifiers if desired. Methods of removing the emulsifiers from the dispersions by anion-exchange and addition of non-ionic emulsifiers are disclosed for example in EP 1 155 055 B1, by addition of polyelectrolytes are disclosed in WO2007/142888 or by addition of non-ionic stabilizers such as polyvinylalcohols, polyvinylesters and the like.

The fluoropolymer content in the dispersions may be increased by upconcentration, for example using ultrafiltration as described, for example in U.S. Pat. No. 4,369,266 or by thermal decantation (as described for example in U.S. Pat. No. 3,037,953) or by electrodecantation. The solid content of upconcentrated dispersions is typically about 50 to about 70% by weight.

Typically, dispersions subjected to a treatment of reducing the amount of fluorinated emulsifiers contain a reduced amount thereof, such as for example amounts of from about 1 to about 500 ppm (or 2 to 200 ppm) based on the total weight of the dispersion. Reducing the amount of fluorinated emulsifiers can be carried out for individual dispersion or for combined dispersion, e.g. bimodal or multimodal dispersions. Typically, the dispersions are ion-exchanged dispersions, which means they have been subjected by an anion-exchange process to remove fluorinated emulsifiers or other compounds from the dispersions. Such dispersions typically contain low amounts of non-fluorinated emulsifiers, typically from 0.1 to 10% by weight based on the polymer (solid content). Typical non-fluorinated surfactants include anionic hydrocarbon surfactants. The term “anionic hydrocarbon surfactants” as used herein comprises surfactants that include one or more hydrocarbon moieties in the molecule and one or more anionic groups, in particular acid groups such as sulfonic, sulfuric, phosphoric and carboxylic acid groups and salts thereof. Examples of hydrocarbon moieties of the anionic hydrocarbon surfactants include saturated and unsaturated aliphatic groups having for example 6 to 40 carbon atoms, preferably 8 to 20 carbon atoms. Such aliphatic groups may be linear or branched and may contain cyclic structures. The hydrocarbon moiety may also be aromatic or contain aromatic groups. Additionally, the hydrocarbon moiety may contain one or more hetero-atoms such as for example oxygen, nitrogen and sulfur. Examples of non-ionic surfactants can be selected from the group of alkylarylpolyethoxy alcohols (although not being preferred), polyoxyalkylene alkyl ether surfactants, and alkoxylated acetylenic diols, preferably ethoxylated acetylenic diols, and mixtures of such surfactants. Typically, the non-ionic surfactant or non-ionic surfactant mixture used will have an HLB (hydrophilic lypophilic balance) between 11 and 16. In particular embodiments, the non-ionic surfactant of mixture of non-ionic surfactants corresponds to the general formula:

RₗO—[CH₂CH₂O]ₙ—[R₂O]ₘ—R₃ (V)

wherein Rₗ represents a linear or branched aliphatic or aromatic hydrocarbon group having at least 8 carbon atoms, preferably 8 to 18 carbon atoms. In a preferred embodiment, the residue R1 corresponds to a residue (R′)(R″)HC— wherein R′ and R″ are the same or different, linear, branched or cyclic alkyl groups. In formula (V) above R₂ represents an alkylene having 3 carbon atoms, R₂ represents hydrogen or a C1-C3 alkyl group, n has a value of 0 to 40, m has a value of 0 to 40 and the sum of n+m is at least 2. When the above general formula represents a mixture, n and m will represent the average amount of the respective groups. Also, when the above formula represents a mixture, the indicated amount of carbon atoms in the aliphatic group Rₗ may be an average number representing the average length of the hydrocarbon group in the surfactant mixture. Commercially available non-ionic surfactant or mixtures of non-ionic surfactants include those available from Clariant GmbH under the trade designation GENAPOL such as GENAPOL X-080 and GENAPOL PF 40. Further suitable non-ionic surfactants that are commercially available include those of the trade designation Tergitol TMN 6, Tergitol TMN 100X and Tergitol TMN 10 from Dow Chemical Company. Ethoxylated amines and amine oxides may also be used as emulsifiers. Typical amounts are 1 to 12% by weight based on the weight of the dispersion.

Further non fluorinated, non-ionic surfactants that can be used include alkoxylated acetylenic diols, for example ethoxylated acetylenic diols. The ethoxylated acetylenic diols for use in this embodiment preferably have a HLB between 11 and 16. Commercially available ethoxylated acetylenic diols that may be used include those available under the trade designation SURFYNOL from Air Products, Allentown, Pa. (for example, SURFYNOL 465). Still further useful non-ionic surfactants include polysiloxane based surfactants such as those available under the trade designation Silwet L77 (Crompton Corp., Middlebury, Conn.) Amine oxides are also considered useful as stabilizing additives to the fluoropolymer dispersions described herein. Other examples of non-ionic surfactants include sugar surfactants, such as glycoside surfactants and the like.

Another class of non-ionic surfactants includes polysorbates. Polysorbates include ethoxylated, propoxylated or alkoxylated sorbitans and may further contain linear cyclic or branched alkyl residues, such as but not limited to fatty alcohol or fatty acid residues. Examples of polysorbates include those according to general structure:

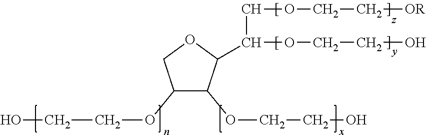

wherein R represents a residue OC—R1 and wherein R1 is a linear, branched, cyclic, saturated or unsaturated, preferably saturated, alkyl, alkoxy or polyoxy alkyl residue comprising 6 to 26, or 8 to 16 carbon atoms. In the above represented formula n, x, y, and z are integers including 0 and n+x+y+z is from 3 to 12. The above general formula represents monoesters but di-, tri- or tetraester are also encompassed. In such case one or more of the hydroxyl hydrogens is replaced by a residue R, wherein the residue R has the same meaning as described above for the monoester.

Useful polysorbates include those available under the trade designation Polysorbate 20, Polysorbate 40, Polysorbate 60 and Polysorbate 80. Polysorbate 20, is a laurate ester of sorbitol and its anhydrides having approximately twenty moles of ethylene oxide for each mole of sorbitol and sorbitol anhydrides. Polysorbate 40 is a palmitate ester of sorbitol and its anhydrides having approximately twenty moles of ethylene oxide for each mole of sorbitol and sorbitol anhydrides. Polysorbate 60 is a mixture of stearate and palmitate esters of sorbitol and its anhydrides having approximately twenty moles of ethylene oxide for each mole of sorbitol and sorbitol anhydrides.

Polyelectrolytes, such as polyanionic compounds (for example polyanionic poly acrylates) may also be added to the dispersion in addition or instead of the surfactants described above. Since the dispersions contain such emulsifiers also the powders may contain such emulsifiers, typically in trace amounts, for example in amounts of less than 10% by weight or even less than 1% by weight or even less than 0.5% by weight or even less than 0.01% by weight (weight percentages are based on the weight of the powder).

The fluoropolymer dispersion whether ion-exchanged or not may be blended to produce multi-modal compositions. The polymer dispersion can be used to prepare dispersions with multimodal, for example bimodal or trimodal fluoropolymer distributions for example by mixing different dispersions. Multimodal fluoropolymer dispersions may present advantageous properties in the reproduction of the article, for example reducing porosity and/or increasing the geometrical accuracy of the fluoropolymer articles produced by additive manufacturing and/or reducing overmelting during the additive manufacturing process. The compositions may be bimodal or multi-modal with respect to particle size distribution (in which case compositions are preferably dry-blended), melt flow rates and/or melting points. Multimodal with respect to flow rates or melting points refers to compositions having two or more components with different melt flow rates and melting points, respectively. Preferably the powders according to the present disclosure and in particular according to the preferred embodiments are monomodal with respect to the fluoropolymer composition or fluoropolymer type but are multimodal with respect to the melt flow rates and/or melting points. This means the fluoropolymer powder contains one fluoropolymer, or two or more fluoropolymers of the same fluoropolymer composition or fluoropolymer type, e.g. one or more fluoropolymers belonging to the FEP, THV, ETFE, THE, PFA type etc. as described above, preferably the PFA type. The two or more fluorpolymers may contain, for example, the same monomers but they may contain them in different amounts as long as they stay within the range required for the specific polymer type. While the preferred powders are monomodal with respect to fluoropolymer composition or fluoropolymer type, they may be multimodal with respect to melt flow, molecular weight and/or melting points. This means, although the powders contain two or more fluoropolymers of the same type, or even of the same composition, the fluoropolymers differ in molecular weight, melting point and/or melt flow rate within the range required for the specific polymer type. For example, they contain two or more fluoropolymers of the same type but with different melting points and/or melt flow rates. Such compositions can be prepared by blending the respective fluoropolymer dispersions in appropriate amounts to adjust the overall melt flow rate(s) or melting point(s) of the resulting fluoropolymer powder (“wet-blending”).

The fluoropolymer powder according to the present disclosure may contain a single fluoropolymer as described above or combination of two or more fluoropolymers as described above. In case a combination is used, the combination is preferably from polymers of the same monomer composition or at least fluoropolymer type (e.g. the polymers are all PFA polymers) but of different melt flow rates and/or of different melting points, i.e. the powder is multimodal with respect to melt flow rates and/or melting points. The fluoropolymers may, for example, have a difference of melt flow rates from 1 to 50 g/10 min (MFI 372/5), preferably from 3 to 30 g/10 mins, more preferably from 2 to 20 g/10 mins. The fluoropolymers may, for example, differ in their melting points by 1° C. to 30° C., preferably by 2° C. to 20° C. The polymers are mixed or blended in a ratio that the overall melt flow rates or melting points of the resulting fluoropolymer powder are within the ranges described herein. In one embodiment of the present disclosure the powder is a monomodal composition with respect to fluoropolymer composition or fluoropolymer type. In another embodiment of the present disclosure the powder is multimodal with respect to at least particle size distribution, melting point, melt flow rate (MFI) or a combination thereof and preferably is monomodal with respect to the fluoropolymer-type, wherein the fluoropolymer type is selected from the group of fluoropolymer types consisting of FEP, THV, PVDF, PFA, ETFE, HTE, preferably PFA. In one embodiment according to the present disclosure the powder comprises at least a first fluoropolymer having an MFI-1 and at least a second fluoropolymer having an MFI-2, wherein the first and the second fluoropolymer are of the same type of fluoropolymer, preferably the first and second fluoropolymer is a PFA fluoropolymer. Preferably, the polymers are selected to have a ratio of MFI-1 to MFI-2 is at least 2, or at least 5, preferably between 3 and 15. Preferably, the overall MFI of the powder (MFI 372/5) is between 1 and 50 g/10 mins, preferably between 2 and 20 g/10 mins.

In one embodiment of the present disclosure the fluoropolymer powder is a blend of two or more fluoropolymers and the powder may have a polydispersity, i.e. a ratio of weight-average molar mass (Mw) to number-average molar mass (Mn) of greater than 1.70, for example at least 1.8 or at least 2.0, for example from 1.8 to 8 or from 1.75 to 3 (which can be determined as described in Fluorinated Polymers: Volume 1: Synthesis, Properties and Simulation, edited by Bruno Améduri and Hideo Sawada, The Royal Society of Chemistry 2017, Chapter 10 (by H. Kaspar)—The Melt Viscosity Properties of Fluoroplastics—Correlations to Molecular Structure and Tailoring Principles, pages 309-358).

Instead of using wet blending to prepare blends of two or more fluoropolymers, dry-blending may be used, for example by blending one or more fluoropolymer powders.

Properties of combinations of fluoropolymers of the same monomers but different MFI's and/or melting points may also be matched by a single fluoropolymer of appropriate polymer architecture instead of using blends of different fluoropolymers. For example, a polymer core-shell architecture or block-copolymer architecture may be created where one part of the polymer, for example the core, corresponds to a polymer of a first MFI or melting point, while a second part of the polymer, for example a shell, corresponds to a polymer with the second MFI or melting point. MFI or melting points can be influenced by adding or varying the amounts of chain transfer agents, reaction initiators or monomer feed and combinations thereof as is known in polymer synthesis.

The fluoropolymer dispersions described above, whether monomodal or multimodal, may be used to produce fluoropolymer powders according to the present disclosure by a process comprising subjecting the dispersion through a nozzle or atomizer to produce a spray and to remove the dispersant, e.g. water in case of aqueous dispersions. Such a process includes spray-drying and freeze-granulation.

The spray-drying can be carried out using the techniques as known in the art as described above or using the specific spray-drying process described above. Spray-drying is carried out with dispersions of the fluoropolymer, preferably aqueous dispersions of the fluoropolymer. The particle size distribution of the powder obtained by spray-drying can be controlled by the gas pressure in the nozzle at a given flow rate. Different nozzles may be used, including, for example two-fluid nozzles, single-fluid nozzles and rotary atomizers. Higher pressure leads to overall smaller particles than lower pressure. The solid content of the dispersion used in the spray drying influences the bulk density of the resulting powder. Higher concentrated dispersions will lead to higher bulk densities. Spray-drying may typically lead to predominantly spherical particles or substantially spherical particles. Predominantly means that the majority (i.e. more than 50%, preferably more than 75% of the particles are spherical or substantially spherical. Substantially spherical means the particles are not exactly spherical but they geometric shape can be best approximated by a sphere, as compared to, for example, a cuboid. Powders obtained by spray-drying typically have on average a sphericity of at least 0.8.

The powders may also be obtained by a process comprising freeze-granulation. For freeze-granulation a fluoropolymer dispersion, preferably an aqueous dispersion, is fed through a nozzle or atomiser similar to spray drying but the resulting droplets are instantaneously frozen, for example by exposing them to liquid nitrogen. The dispersing medium (i.e. water) is removed, for example by sublimation to yield a powder. Powders obtained by freeze-granulation were found to have an even greater sphericity than powders obtained by spray-drying, for example having a sphericity of 0.90 or greater.

The powders obtained by spray-drying or freeze-granulation may be passed though one or more sieve or air classifier or a combination thereof for removing particles of a certain diameter range.

Alternatively, or in addition, the powders according to the present disclosure may be produced by a process comprising milling. Powders obtained by spray-drying or freeze granulation may be subjected to milling, although this is not preferred. Instead the fluoropolymer dispersions described above may be further processed to isolate the fluoropolymer particles from the dispersions and to produce “secondary” particles including coagulates, agglomerates and pellets. Such “secondary particles” may have a diameter or longest axis of from at least 0.5 μm, 1 μm or at least 5 μm. For making “secondary particles” the fluoropolymers described herein may be collected by deliberately coagulating them from the aqueous dispersions, for example by stirring at high shear rates. In another embodiment, a coagulating agent, such as for example, an ammonium carbonate, a polyvalent organic salt, a mineral acid, a cationic emulsifier or an alcohol or a combination or a sequence thereof may be added to the aqueous emulsion to deliberately coagulate the polymers. Agglomerating agents such as hydrocarbons like toluenes, xylenes and the like may be added to increase the particle sizes and to form agglomerates. The use of agglomerating agents, in particular in the presence of mineral acids and while stirring lead to the formation of spherical particles. Drying of the washed polymer particles can be carried out at an optional temperature, such as for example, drying within a range of from 100° C. to 300° C. The coagulates or agglomerates may have an average particle size (number average) of greater than 150, 300, 400, 500, 1000, or even 1500 μm (micrometers). The particle sizes may be increased further by melt-pelletizing.

The coagulated fluoropolymers or melt pellets may be subjected to a fluorination treatment as described, to remove thermally unstable end groups. Unstable end groups include —CONH2, —COF and —COOH groups. Fluorination is conducted so as to reduce the total number of those end groups to less than 100 per 10⁶ carbon atoms in the polymer backbone. Suitable fluorination methods are described for example in U.S. Pat. No. 4,743,658 or DE 195 47 909 A1. The amount of end groups can be determined by IR spectroscopy as described for example in EP 226 668 A1.

The fluoropolymer powder according to the present disclosure may also be prepared by milling of solid fluoropolymer compositions, for example the “secondary particles” described above and preferably coagulated and/or agglomerated fluoropolymer. The powder obtained by may be passed though one or more sieve or air classifier or a combination thereof for removing particles of a certain diameter range.

Milling can be carried out as is generally known in the art of making fluoropolymer powders as described, for example in US patent application No 2006/0142514 A1. Milling equipment, sieves and air classifiers as known in the art, for example for milling and sieving equipment for making fluoropolymer coating powders as described US 2006/0142514 A1, may be used. Sieves may be used to control the particle population for example by excluding (removing) particles of a certain diameters from the powder. Air classifiers may be used in addition or as alternative to remove small particles by “blowing them off” from the composition. This way the smallest and largest particles sizes of the powders can be controlled but sieving or milling and air classifiers may also be applied to spray-dried powders to exclude certain particles sizes from the powder. Powders according to the present disclosure may be prepared by milling and optionally sieving from the “secondary particles” described above, preferably by milling coagulates of the appropriate particle sizes. Larger particles may be removed by sieves to make sure particles above a certain particle size are excluded. Appropriate particle size distributions may also be obtained by blending (dry-blending) powders of known particle size distributions in appropriate amounts.

Contrary to the spray-drying method, the particles sizes of the starting fluoropolymer composition get reduced by milling. Powders prepared by milling may not be sintered. In one aspect of the preferred embodiments the powder is obtained by a process comprising milling a fluoropolymer composition of larger particles and separating off particle fractions with larger or smaller particle sizes than desired.

The milling and sieving steps may be repeated until the powder has the appropriate particle size distribution. Typically, the powders obtained by milling are less spherical than powders obtained by spray-drying or freeze-granulation and may have an average sphericity of less than 0.8, or less than 0.7. They may also have a greater flow time than powders obtained by spray-drying or freeze-granulation. In one embodiment of the present disclosure the powder is obtained by milling and comprises a blend of two or more polymers of the same fluoropolymer type or even same composition but of different melting points and/or melt flow rates. Such a powder can be obtained by blending different powders in appropriate amounts.

The powders according to the present disclosure have favorable properties for 3D-printing, for example spreadability and flowability and do not require the addition of any flow agents or other additives. Flow agents include, for example, inorganic particles including carbon black, graphite, inorganic particles containing silicon oxides and/or aluminum oxides. The powders according to the present disclosure are essentially free of such flow agents. “Essentially free” means containing no or only trace amounts, such as impurities, for example less than 0.1% by weight or even 100 ppm or less and including 0. While additives are not required for the performance of the powders according to the present disclosure for making articles by additive manufacturing, additives may be added if desired. Preferably, the powders according to the present disclosure comprise at least 75% by weight, more preferably at least 90% by weight and even more preferably at least 95% by weight of fluoropolymer (percentages are based on the total weight of the powder, which is 100% by weight). Most preferably the powders consist essentially of fluoropolymer, by which is meant that powder contains only fluoropolymer but may contain trace amounts of impurities such as residues from the polymer production or work up processes, like for example emulsifiers, and such trace amounts are less than 5% by weight, preferably less than 1% by weight (based on the weight of the powder).

The powder according to the present disclosure can be used for producing a three-dimensional fluoropolymer article, in particular by additive processing, preferably by selective laser sintering (SLS). Processes for manufacturing three-dimensional articles, and in particular by selective laser sintering of polymer powders are known in the art. Typically, additive manufacturing by selective laser sintering comprises the steps of:
i) providing a layer of the powder according to the present disclosure in a confined region;
ii) selectively treating an area of the layer of the powder by irradiation with a laser beam to fuse the powder
iii) repeating steps a) and/or b) to generate a three-dimensional article comprising the fused powder.

Typically, the article is built up layer-by-layer and a new layer of powder is added to the powder bed after each building step. Processing of the powder can be carried out in commercial additive processing devices including commercial selective laser sintering devices or 3D-printers.

Advantages and embodiments of this invention are further illustrated by the following list of embodiments and examples, but the particular materials and amounts thereof recited in these examples, as well as other conditions and details, should not be construed to unduly limit this invention.

The present disclosure is further illustrated by the following examples. These examples are merely for illustrative purposes only and are not meant to be limiting on the scope of the appended claims.

### Methods

Average particle size and particle size distribution of powders: The particle size distributions of the powders were determined by laser diffraction method according to Test Method ISO 13320 using a Sympatec Helos measurement device (HELOS-R Series, from Sympatec GmbH, Clausthal-Zellerfeld, Germany). The sample size of powders measured was 2 ml. The measurement range was from 0.9 μm to 175 μm.

Average particle size in aqueous dispersions: Average particle size of polymer particles as polymerized can be measured by electronic light scattering using a Malvern Autosizer 2c in accordance with ISO 13321. This method assumes a spherical partical size. The average particle sizes are expressed as the Z-average.

Average particle sphericity: The sphericity (ratio of the length of longest axis of the particles (first axis) to the length of longest axis perpendicular to the first axis was determined by scanning electron microscopy (SEM) images taken on a PHENOM G2 PURE SEM from ThermoFischer Scientific) using the imaging software of the microscope (sample size includes at least 50 particles). The sphericity indicated is the arithmetic mean.

Melt flow index: The melt flow index (MFI), reported in g/10 min, can be measured with a Goettfert MPD, MI-Robo, MI4 melt indexer (Buchen, Germany) at a support weight of 5.0 kg and a temperature of 265° C. (DIN EN ISO 1133-1). The MFI is obtained with a standardized extrusion die of 2.1 mm in diameter and a length of 8.0 mm.

Melting Point: Melting points can be determined by DSC (a Perkin Elmer differential scanning calorimeter Pyris 1) according to DIN EN ISO 12086). 5 mg samples can be heated at a controlled rate of 10° C./min to a temperature of 380° C. by which the first melting temperature is recorded. The samples are then cooled at a rate of 10° C./min to a temperature of 30° C. below the recorded first melting temperature and then reheated at 10° C./min to a temperature at 380° C. The melting point observed at the second heating period is recorded and is referred to herein as the melting point of the polymer.

Bulk density: The bulk density was determined according to DIN EN ISO 60:2000-1.

Powder flow time: Powder flow time was determined according to DIN EN ISO 12086:2006-1.

Comonomer Content: The comonomer content in the polymers described herein can be determined by infrared spectroscopy using a Thermo Nicolet Nexus FT-IR spectrometer. In the case of the MV-31 containing polymers the comonomer content in % wt was calculated as 1.48× the ratio of the sum of the 891 and the 997 cm⁻¹ absorbance to the 2365 cm⁻¹ absorbance. All other comonomer contents were calculated as 0.95× the ratio of the 993 cm⁻¹ absorbance to the 2365 cm⁻¹ absorbance (compare U.S. Pat. No. 6,395,848).

Solid Content: The solid content (fluoropolymer content) of the dispersions can be determined gravimetrically according to ISO 12086. A correction for non-volatile ingredients is not carried out.

Elongation at break and tensile strength at break: Elongation at break and tensile strength at break can be determined according to DIN EN ISO 527-1 using a Zwick Tensile Tester. Test specimen are elongated at a speed of 50 mm/min at room temperature (22° C.+/−3° C.). Test samples can be prepared as follows: dried polymer samples are given in a circular mold having a diameter of 130 mm and then press-molded at 360° C. and 53 bar for 2 minutes. The disks are removed from the mold and kept at 23° C. and 50% relative humidity for 16 hours. Test specimen (according to DIN ISO 12086) are cut from the disks and subjected to tensile tester.

### EXAMPLES

### Example 1

A PFA fluorothermoplastic aqueous dispersion PFA6900GZ (available from the 3M Company, USA) is fed into a spray dryer (Model Niro Mobil Minor 2000, available from Aaron Equipment Company, Denmark) and spray dried in a counter flow setup, using the below-mentioned parameters:

Inlet temperature: 190° C.; Outlet temperature: 84° C.; Fan power: 85%; Tp (pressure difference inlet-outlet): 32 mmWS; p nozzle (air flow to nozzle): 35%; Pump: 20 rpm.

The drying air temperature far below the melting point of PFA (about 305° C.) ensures that water from the aqueous dispersion is evaporated, but the obtained fluoropolymer particles are not sintered.

The obtained powder is thereafter exposed to a temperature of 295° C. for 4 hours using heated gas in an oven. This additional thermal treatment (hardening step) allows slightly glazing the external surface of the fluoropolymer particles.

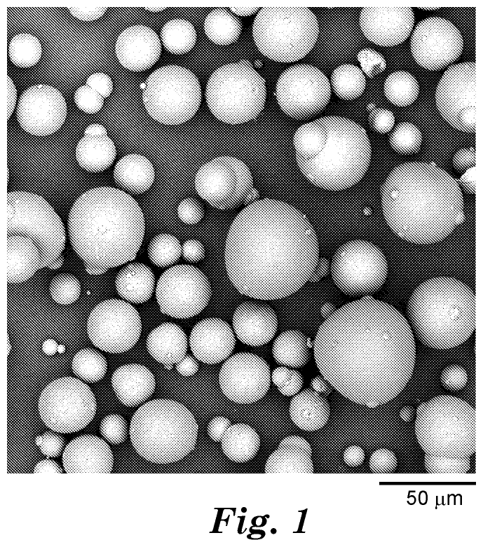

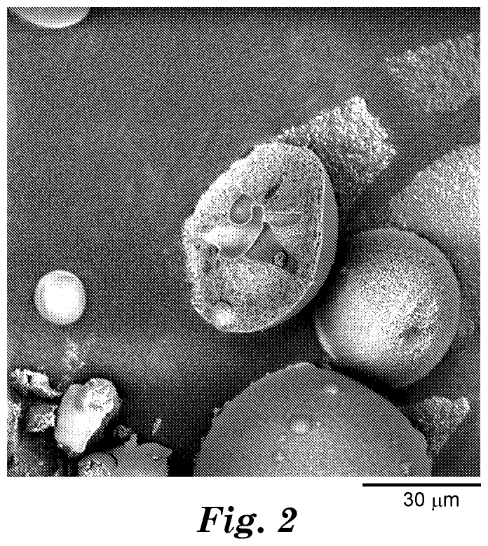

The resulting fluoropolymer particles have an average particle size (d₅₀) of about 32 micrometers, an average particle size (d₉₀) of about 67 micrometers, and an average particle size (d₁₀) of about 7 micrometers. The resulting fluoropolymer particles further have an average particle sphericity of 0.92. As can be seen from FIG. 1 (SEM images showing the powder obtained according to the process of the invention), the fluoropolymer particles have a highly spherical shape and a smooth surface. The fluoropolymer particles are further characterized by an inner porous structure, as shown in the SEM image referred to as FIG. 2.

The powder obtained according to the process of the invention has a bulk density of about 832 g/1, and a powder flow of about 9.5 seconds/100 ml. The suitability for laser sintering, in particular selective laser sintering, was confirmed in a powder bed test, where a thin powder layer was spread with a blade. The powder obtained according to the process of the invention gave a powder bed with a very smooth surface and spread without agglomeration or cohesion.

### Example 2

A PFA-powder with a different PFA polymer (melting point 308° C., MFI 3 g/10 min) was prepared. 4.5 kg of an aqueous dispersion (solid content about 60%) of a PFA polymer was subjected to spray-drying in the same spray-drying equipment used in example 1. The results are shown in table 2. The processing conditions are summarized in table 1.

### Example 3

A PFA-powder was prepared from a PFA having a melting point about 310° C. and an MFI (372/5) about 15. 4.5 kg of an aqueous dispersion (solid content about 60%) was subjected to spray-drying in the same spray-drying equipment of example 1. The results are shown in table 2. The processing conditions are summarized in table 1. All powders obtained by spray-drying were spherical powders (sphericity>0.8) and similar to the particles shown in FIG. 1. The sphericity (ratio of the length of longest axis of the particles (first axis) to the length of longest axis perpendicular to the first axis was determined by scanning electron microscopy (SEM) images taken on a PHENOM G2 PURE SEM from ThermoFischer Scientific) using the imaging software of the microscope (sample size includes at least 50 particles). The sphericity indicated is the arithmetic mean.

### Comparative Example 1

A PFA powder was prepared by milling (agglomerated PFA particles, melting point 308° C., MFI 3 g/10 min). The results are shown in table 2.

### Comparative Example 2

A PFA powder was prepared by milling the same polymer as used in example 1 but to provide a larger powder than that of example 1. Milling was carried out generally as described in US patent application 2006/0142514 A1 (Blake E. Chandler et. al). The results are shown in table 2.

### Example 4

The powder of comparative example 2 was used and sieved using a 100 μm sieve to remove particles above 100 μm. The results are shown in table 2.

TABLE 1
conditions of spray-drying used in examples 1 to 3

| | Ex 2 | Ex 1 | Ex 3 |
|---|---|---|---|
| Temperature | 200° C. | 190° C. | 200° C. |
| (inlet) | | | |
| Temperature | 94° C. | 84° C. | 85° C.-90° C. |
| (outlet) | | | |
| P(nozzle) | 35% | 35% | 37% |
| (air flow to | | | |
| nozzle) | | | |
| pump | 25 rpm | 20 rpm | 25-30 rpm |

TABLE 2
results of examples 1 to 4 and comparative examples 1 and 2

| | | | | Bulk | | |
|---|---|---|---|---|---|---|
| | | | | Density | Flow Time | |
| | D10 | D50 | D90 | [g/L] | [seconds/100 ml] | Powder Beds |
| Example 1 | 7 | 32 | 67 | 832 | 9.5 | Very spreadable, |
| | | | | | | very smooth |
| | | | | | | powder bed with |
| | | | | | | no visible gaps |
| Example 2 | 14 | 38 | 79 | 900 | 6.9 | Very spreadable, |
| | | | | | | very smooth |
| | | | | | | powder bed with |
| | | | | | | no visible gaps |
| Example 3 | 5 | 35 | 91 | 886 | 7.8 | Very spreadable, |
| | | | | | | very smooth |
| | | | | | | powder bed with |
| | | | | | | no visible gaps |
| Example 4 | 17 | 48 | 98 | >800 | | Spreadable, |
| | | | | | | smooth powder |
| | | | | | | bed with no or |
| | | | | | | very few visible |
| | | | | | | gaps |
| Comparative Ex 1 | 6 | 25 | 56 | 807 | | Spreadable, but |
| | | | | | | with visible |
| | | | | | | surface defects; |
| | | | | | | rough surface |
| Comparative Ex 2 | 37 | 77 | 127 | 910 | | Spreadable, but |
| | | | | | | with visible |
| | | | | | | surface defects; |
| | | | | | | rough surface |

The results shown in table 2 indicate that a very fine powder (comparative example 1) lead to powder beds with visible surface defects as did coarse powders (comparative example 2). Such surface defects will lead to imperfections in the 3D printed article made from such a powder. Spray-dried powders were more spherical (higher sphericity) than powders obtained by milling.

### Example 5

A PFA fluoropolymer powder was prepared by freeze granulation. Freeze granulation was carried out using the PowderPro Freeze granulator LS-2, from PowderPro AB, Sweden. A 1 L beaker was filled with liquid nitrogen, which was stirred by a magnetic stirrer at 400 rpm. The PFA-fluoropolymer dispersion was atomized in a two-substance nozzle into a fine spray with a flow rate of 21/h and 0.2 bar nitrogen and sprayed into stirred liquid nitrogen. The formed droplets froze instantaneously. In a subsequent freeze-drying step the frozen granules were dried by sublimation of ice in an ALPHA 2-4 LSCplus freeze dryer from Martin Christ Gefriertrocknungsanlagen GmbH, Germany, under vacuum (1.5 mbar vacuum was applied). Within 24 h the temperature was increased to 18° C. at constant pressure of 1.5 mbar. In a post-drying step the temperature was raised from 18° C. to 22° C. at a simultaneous pressure reduction from 1.5 mbar to 0.5 mbar. The powder had a D50 of 100 μm and a sphericity (determined as described in example 3 of greater than 0.95).

### Example 6

A broadly distributed terpolymer consisting of 53 mol % TFE, 11 mol % HFP and 36 mol % VDF (THV) was prepared in a multi-stage polymerization process using an oxygen free reactor with a total volume of 1678 l equipped with an anchor blade agitator system. The vessel was charged with 1030 l deionized water, 70 g oxalic acid, 425 g ammonium oxalate and 7.9 kg of a 30% aqueous partially fluorinated emulsifier (CF3OCF2CF2CF2OCF2CFH—COONH4) solution. The kettle was then heated up to 60° C. and the agitation system was set to 80 rpm. The reactor was pressurized with hexafluoropropylene (HFP) to a pressure of 9.1 bar absolute, with vinylidene fluoride (VDF) to 11.5 bar absolute and with tetrafluoroethylene (TFE) to 15.5 bar absolute reaction pressure. The polymerization was initiated by the addition of 1200 ml 1.0% aqueous potassium permanganate (KMnO4) solution and a continuous feed of KMnO4-solution was maintained with a feed rate of 800 ml/h. After the reaction started, the reaction temperature of 60° C. and the reaction pressure of 15.5 bar absolute was maintained by feeding TFE, VDF, and HFP into the gas phase with a HFP/TFE (kg) feeding ratio of 0.313 and a VDF (kg)/TFE (kg) feeding ratio of 0.430. When the total feed of 12.2 kg TFE was accomplished after 10 min, the reaction pressure was increased by 0.4 bar by the addition of 280 g ethane chain transfer agent. The reaction pressure reverted back to the target polymerization pressure of 15.5 bar within 14 min, while the feeding of the monomers was temporarily interrupted. Then, the polymerization was continued to a total feed of 152.6 kg TFE, which was reached after 217 min total polymerization time. Then, the reaction pressure was increased by 1.3 bar by the addition of 910 g ethane chain transfer agent. It only took 5 min for the reaction pressure to revert back to the target polymerization pressure of 15.5 bar while the feeding of the monomers was continued. The polymerization was continued to the target monomer feed 305.2 kg TFE, which was reached after 310 min total polymerization time. The monomer feed was interrupted by finally closing the monomer valves and the residual monomers were reacted down to 11.0 bar within 10 minutes. Then, the reactor was vented and flushed with nitrogen gas in three cycles. The thus obtained polymer dispersion was removed at the bottom of the reactor, the dispersion had a solid content of 34.1% and an average latex particle diameter of 95 nm as determined by dynamic light scattering. The dispersion was passed through a glass column containing DOWEX 650C cation exchange resin (Dow Chemical Co, Midland, Mich.). The dispersion was shear coagulated using a GAULIN homogenizer (type 106MC4-8,8TBSX) and placed onto a continuous washing/filtration belt (available from Pannevis; Utrecht/Holland). The washed polymer powder was dried for 10 hours under reduced pressure at 110° C. in a tumbling drier available from OHL Apparatebau (Limburg a.d. Lahn/Germany). The polymer powder had an MFI (265/5) of 18.1 g/10 min and a melting point maximum at 160° C. The Dispersity (Ð=M_{w}/Mₙ) was 3.0. By appropriate sieving similar to the methods described in US patent application 2006/0142514 A1 (Blake E. Chandler et. al) a particle distribution of d₅₀ of 33 μm and d₉₀ of about 80 μm can be achieved and this powder can be subjected to additive manufacturing as described in example 7.

### Example 7

A PFA powder according to example 4 (MFI 372/5 of 3 g/10 min) was used to prepare articles by selective laser sintering on a SLS printer from Farsoon Technologies (Faarsoon Technologies Europe, Stuttgart, Germany) using a CO₂-laser. The articles prepared were cylinders of approximately 2 cm diameter and approximately 2 cm length. The cylinders contained in their center a cylindrical aperture extending across the entire length of the cylinder thus forming a hollow cylinder within the cylindric article. The hollow cylinder had a diameter of about half a centimeter. Selective laser sintering was carried out at laser energies of 190 mJ/mm³ and 1300 mJ/mm³. In both cases the article was formed with good geometric accuracy and no overmelting (i.e. the inner hollow cylinder was intact). The surface of the article appeared smooth and even. The resulting article had a density of 0.8 g/cm³ (DIN EN ISO 1183-1) when a laser energy of 190 mJ/mm³ was used and a density of 1.5 g/cm³ at a laser energy of 1300 mJ/mm³. Some overmelting occurred (hollow cylinder was no longer intact but was partially filled with polymer) when a laser energy of 2250 mJ/mm³ was applied for SLS-printing.

### Example 8

A fluoropolymer powder having an overall MFI of 3 g/10 min (MFI 372/5) containing a blend of two PFA polymers having the same chemical composition but different melt flow rates was subjected to additive manufacturing by selective laser sintering on the same printer as described above for Example 7 to produce an article as described above in Example 7. At a laser energy of 300 mJ/mm³ an article with a smooth and even surface, accurate geometry, no overmelting and a density of 2.0 g/cm³ was obtained.

### Comparative Example 3

The powder of comparative example 1 was subjected to additive manufacturing at the same printer described in Example 7 to produce the article as described in Example 7. The article could not be produced because the process stalled before an article having a length of about 1 cm could be produced.

### Comparative Example 4

The powder of comparative example 2 was subjected to additive manufacturing at the same printer described in Example 7 to produce the article as described in Example 7. The article could not be produced because the process stalled before an article having a length of about 1 cm could be produced.

1. A fluoropolymer powder for additive manufacturing of fluoropolymers having wherein the powder has a particle size (d₁₀) in a range from 3 to 40 micrometers, a particle size (d₅₀) in a range from 20 to 100 micrometers, and a particle size (d₉₀) in a range from 60 to 120 micrometers, a sphericity of at least 0.8, a bulk density of at least 800 g/l and no greater than 2000 g/l when measured according to DIN EN ISO 60:2000-1, and a flow time of no greater than 20 seconds per 100 ml when measured according to DIN EN ISO 12086:2006-1.

2. The powder of claim 1 wherein the powder has a flow time between 4 and 20 seconds per 100 ml.

3. The fluoropolymer powder of claim 1 wherein the powder has a particle size (d₁₀) in a range from 10 to 30 micrometers.

4. The fluoropolymer powder of claim 1 having a sphericity of at least 0.9.

5. The fluoropolymer powder of claim 1 having an MFI (373/5) of between 1 g/10 min and 25 g/min.

6. The fluoropolymer powder of claim 1 having at least one melting point between 110° C. and 320° C.

7. The fluoropolymer powder of claim 1, wherein the fluoropolymer comprises repeating units derived from vinylidene fluoride (VDF).

8. The fluoropolymer powder of claim 1, wherein the fluoropolymer comprises repeating units derived from tetrafluoroethene (TFE) and one or more comonomers selected from hexafluoropropene (HFP), ethene (E), propene (P), perfluoro vinyl ether (PAVE), perfluoro allyl ether (PAAE) and combinations thereof.

9. The fluoropolymer powder of claim 8, wherein the fluoropolymer is selected from copolymers of TFE and one or more comonomers selected from PAVE's, PAAE's and combinations thereof.

10. The fluoropolymer powder of claim 1 obtained by subjecting a fluoropolymer dispersion to a process comprising spray-drying or freeze-granulation.

11. The fluoropolymer powder of claim 1 obtained by a process comprising subjecting a solid composition of fluoropolymer particles to milling and sieving.

12. The fluoropolymer powder of claim 1 wherein the powder is a monomodal composition with respect to the fluoropolymer composition or fluoropolymer type.

13. The fluoropolymer powder of claim 1 wherein the powder is multimodal with respect to at least particle size distribution, melting point, melt flow rate (MFI) or a combination thereof and preferably is monomodal with respect to the fluoropolymer-type, wherein the fluoropolymer type is selected from the group of fluoropolymer types consisting of FEP, THV, PVDF, PFA, ETFE, HTE, preferably PFA.

14. The fluoropolymer powder of claim 1 having a polydispersity between 1.80 and 8.

15. A process of making the fluoropolymer powder of claim 1 comprising subjecting a fluoropolymer dispersion to spray-drying or freeze-granulation.

16. A process for making the fluoropolymer powder of claim 1 comprising providing a fluoropolymer powder and milling the powder and sieving of the milled fluoropolymer powder.

17. A process for making the fluoropolymer powder according to claim 1 wherein the processes comprises blending two or more fluoropolymer compositions.

18. A three-dimensional article obtained by subjecting the fluoropolymer powder of claim 1 to additive manufacturing.

19. The three-dimensional article of claim 18, wherein the article is obtained by subjecting the fluoropolymer powder to selective laser sintering (SLS).

20. A process for making a three-dimensional article comprising subjecting the fluoropolymer powder of claim 1 to selective laser sintering.
